(19) United States
(12) Patent Application Publication
(10) Pub. No.: US 2009/0048012 A1
(43) Pub. Date: Feb. 19, 2009

(54) Networked Gaming System and Method Providing Multiple Group Play Awards Based on Different Criteria

(75) Inventors: Pravinkumar Patel, Henderson, NV (US); Josh Larsen, Las Vegas, NV (US); John Vallejo, Henderson, NV (US); David Schultz, Henderson, NV (US); Keith Kruczynski, Las Vegas, NV (US); Alexander Villagran, Las Vegas, NV (US); Harlan J. Darrah, Sparks, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/258,330

(22) Filed: Oct. 24, 2008

Related U.S. Application Data
(63) Continuation-in-part of application No. 11/938,079, filed on Nov. 9, 2007.
Application No. 11/938,079 is a continuation-in-part of application No. 11/745,286, filed on May 7, 2007.
Application No. 11/745,286 is a continuation of application No. 10/794,388, filed on Mar. 5, 2004, now abandoned.
Application No. 11/938,079 is a continuation-in-part of application No. 11/537,471, filed on Sep. 29, 2006.
Application No. 11/537,471 is a continuation-in-part of application No. 11/428,220, filed on Jun. 30, 2006.
Application No. 11/428,220 is a continuation-in-part of application No. 11/938,149, filed on Nov. 9, 2007.
(60) Provisional application No. 60/986,765, filed on Nov. 9, 2007.
(60) Provisional application No. 60/452,912, filed on Mar. 7, 2003.
(60) Provisional application No. 60/865,635, filed on Nov. 13, 2006.

(51) Int. Cl. A63F 9/24; A63F 13/00

(52) U.S. Cl. 463/20

(57) ABSTRACT

Disclosed are systems and methods for group play gaming including multiple variations of awards. Upon a triggering event, gaming machines operate in a group play mode which includes multiple award opportunities for each player which may include a grand prize award, one or more mystery prize awards, and one or more progressive awards.

### RELATED APPLICATIONS

This application claims the benefit of U.S. provisional patent application 60/986,765 filed on Nov. 9, 2007, which is hereby incorporated by reference in its entirety for all purposes.

This application is a continuation-in-part of U.S. patent application Ser. No. 11/938,079 entitled “NETWORKED SYSTEM AND METHOD FOR GROUP PLAY GAMING,” filed on Nov. 9, 2007, which is a continuation-in-part of U.S. patent application Ser. No. 11/745,286, filed May 7, 2007, which is a continuation of U.S. application Ser. No. 10/794,388, filed on Mar. 5, 2004, which claims the benefit of U.S. Provisional Application Ser. No. 60/452,912, filed Mar. 7, 2003. Application Ser. No. 11/938,079 is also a continuation-in-part of U.S. patent application Ser. No. 11/537,471, filed Sep. 29, 2006, which is a continuation-in-part of U.S. application Ser. No. 11/428,220, filed on Jun. 30, 2006, each of which are hereby incorporated by reference in their entirety for all purposes.

This application is a continuation-in-part of U.S. patent application Ser. No. 11/938,149 entitled “NETWORKED GAMING SYSTEM AND METHOD WITH A POINT-BASED AWARD,” filed on Nov. 9, 2007 which claims priority from provisional application 60/865,635 filed on Nov. 13, 2006, both of which are hereby incorporated by reference in their entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to group play gaming and methods and, more particularly, to gaming networks and methods for providing multiple group play awards.

2. Description of the Related Art

In the prior art, various types of gaming machines have been developed with different features to captivate and maintain player interest. In general, a gaming machine allows a player to play a game in exchange for a wager. Depending on the outcome of the game, the player may be entitled to an award which is paid to the player by the gaming machine, normally in the form of currency or game credits. Gaming machines may include flashing displays, lighted displays, or sound effects to capture a player's interest in a gaming device.

Gaming tournaments are a popular practice in casinos. A slot machine tournament is a group activity that can engender additional excitement and enjoyment for players. Group play tournaments are known which require a player to pay an entry fee to join the tournament. Also found in the art are gaming machines that are used for tournaments and configured for tournament play with high win frequencies. In one example of tournament play, upon the start of the tournament, a controller enables all machines for play and the players play as rapidly as they can to accumulate points “paid” for winning outcomes on the game. At the end conclusion of the tournament, usually a fixed period of time, all of the slot machines are disabled by the controller. The points accumulated by each machine are ranked and a set of participants having the highest accumulated number of points are declared the winners and awarded predetermined portions of the entry fees.

While tournaments and other group play activities such as table games have been very successful, there remains a need for group games that provide a player with enhanced excitement and increased opportunity of winning.

### SUMMARY OF THE INVENTION

In accordance with one or more embodiments of the invention, a networked gaming system includes a group play controller and a plurality of gaming machines operably connected to the group play controller and operable in a group play mode to compete for one or more awards based on achieving a highest score. The group play controller provides one or more additional mystery awards based on an event or achievement other than the highest score.

In accordance with one or more other embodiments of the invention, a networked group play gaming system includes a group play controller and a plurality of gaming machines operably connected to the group play controller and operable in a group play mode to compete for one or more awards based on achieving a highest score. The group play controller provides one or more additional progressive awards based on an event or criteria other than the highest score.

The additional awards may have criteria which are known or unknown to the players.

Further aspects, features and advantages of various embodiments of the invention may be apparent from the following detailed disclosure, taken in conjunction with the accompanying sheets of drawings.

### BRIEF DESCRIPTION OF THE DRAWINGS

FIG. 1 is a perspective view of an example bank of group play gaming machines in accordance with one or more aspects of the present invention.

FIG. 2 is a schematic block diagram showing the hardware elements of an example networked group gaming system in accordance with one or more aspects of the present invention.

FIGS. 3A and 3B are a functional block diagram depicting the steps associated with carrying out an example method in accordance with one or more aspects of the invention.

FIG. 4 is a perspective view of a gaming machine in accordance with one or more aspects of the present invention.

FIG. 5 is a block diagram of the physical and logical components of an example motherboard of the gaming machine of FIG. 4.

FIG. 6 shows the front of a video display and display image of an example game such as may be displayed and shown on a gaming machine.

FIG. 7 is a display image associated with an example help screen in accordance with one or more embodiments of the invention.

FIG. 8 is a display image associated with an example feature game in accordance with one or more embodiments of the invention.

FIG. 9 is a display image associated with an example indicator in accordance with one or more embodiments of the invention.

FIG. 10 is a schematic block diagram showing the hardware elements of an example networked gaming system in accordance with one or more aspects of the present invention.

### DETAILED DESCRIPTION OF THE PREFERRED EMBODIMENTS

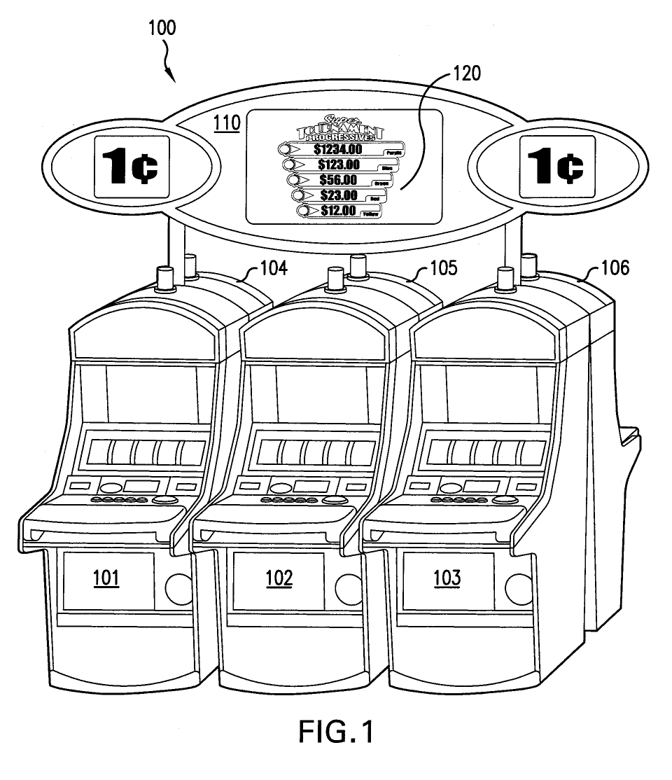

Various embodiments are directed to a networked gaming system, gaming machines and game and their associated methods for playing a group play game. Embodiments of one or more games, gaming machines, networked gaming systems and methods are illustrated and described herein, by way of example only, and not by way of limitation. Referring now to the drawings, and more particularly to FIGS. 1-10, there are shown illustrative examples of one or more games, gaming machines, networked gaming systems, and methods for playing a game in accordance with various aspects of the invention.

In accordance with one or more embodiments of the invention, FIG. 1 illustrates an example bank 100 of six gaming machines 101-106. Gaming machines 101-106 operate independently accepting wagers, producing game results and awarding cash prizes in the form of currency, negotiable instruments, coupons, tokens or credits for any winning outcomes. However, gaming machines 101-106 are also linked by way of a network and a group play gaming controller for competitive play of a group play game in which, from time-to-time, a number of players playing the networked gaming machines 101-106 may compete for one or more of a set of group play progressive awards, the amounts of which are displayed on shared gaming display 120 as part of sign 110.

In one or more embodiments, group play mode is initiated by an event at one of the participating gaming machines. For example, a game in accordance with one or more aspects of the invention may be one of a set of primary games randomly selected for play following initiation of gaming machine play by the player and a group play game may be one of the set of primary games that may be randomly selected. For example, U.S. application Ser. No. 11/428,220, entitled “Multiple Primary Games Triggered by Random Number Generator,” filed on Jun. 30, 2006, hereby incorporated by reference its entirety, discloses a gaming machine including at least two distinct primary games. After receiving a wager, the gaming machine determines which primary game to activate. In accordance with one or more embodiments of the invention, group play mode may be initiated when one of the participating gaming machines selects a group play primary game, at which time the group gaming controller notifies other potentially eligible networked gaming machines of the event and invites them to join group play if eligible. Players at eligible gaming machines may accept and, if players at two or more eligible gaming machines elect group play, then group play ensues. In accordance with one or more embodiments, more than one group play game is available for random selection once a triggering event has occurred. In another embodiment, the player of the gaming machine that causes the triggering event is allowed to select a group play game from a set of group play games.

During group play, normal operation of the slot machines is suspended, at which time players participate in a tournament or group game, accumulating points for winning outcomes on their gaming machines according to a tournament or group game point pay table rather than a standard pay table. In one or more embodiments, play of the tournament games does not require a wager.

At the end of the tournament or group game, the players are ranked according to their accumulated points. In one or more embodiments, prizes are awarded according to the players' rankings. In still other embodiments, some players are eligible for progressive award prizes. For example, the three players with the top point totals may qualify to receive one of a set of progressive awards if they have earned enough points during the tournament. In one or more embodiments, the number of progressive awards in the set is five as shown in example shared gaming display 120, but the number of progressive awards may vary. Those players not eligible for a progressive prize based on either their finishing position (1^{st}, 2^{nd}, 3^{rd}, etc.) or their total tournament points may receive a consolation prize. In one or more embodiments, the consolation prize is a multiple of the player's last wager prior to the start of the tournament.

In one or more embodiments, one or more additional awards may be won during the course of the tournament or group game based on one or more criteria, such as one or more of the following: the first player to play ten games, or the first player to accumulate a pre-determined number of points, or when any player hits a jackpot, or when any player is selected from a random or quasi-random number generator (“mystery award”). In the case of a mystery award from a random or quasi-random number generator, the generator may be triggered at a pre-determined programmed time or may itself be trigger randomly during the tournament or group play. Alternatively or additionally, the random or quasi-random number generator may trigger based on a combination hit by one of the players or may trigger based on some other pre-determined event. In the case of the triggering of the random or quasi-random generator by a combination hit by one of the players, any of the players may ultimately win the mystery award. In the case of a quasi-random number generator, the player hitting the trigger may receive a greater chance of winning the mystery award and/or players may have their chance of winning the mystery award weighted based on additional criteria, such as based on a player's recent or historical playing or player tracking data. Some or all of the criteria for the awards may or may not be known to the players.

It may further be appreciated that multiple of the awards may be winnable during a single tournament or group play depending upon the mathematics associated with the awards and the amounts awarded on each instance. For example, in the case of an award triggered by the first to achieve a specified milestone, a counter may be reset so that each of the players can again play for the award based on the next to achieve the milestone; or, once a player achieves a winning milestone, that person may be eliminated from obtaining an additional award based on achieving the milestone a second time or a next milestone. For example, one player may be the first to achieve 1000 points and may receive an award; then each player may have a point counter that is reset and allows the players to again play until a player hits a next occurrence of 1000 points. In this case, the first player to win the award may or may not be eligible to win the award on the second occurrence. Alternatively, the count may not be reset after the first milestone (1000 points) is hit and instead, the other players (not including the first winner) may play to win an award for the first to reach 2000 points.

In the case of a mystery award, clearly that may be set to trigger one or more times during a single session, again depending upon the sizes of the awards and the associated mathematics which should preferably be set so as not to exhaust the award pool, if not in every case, then at least on a statistical basis.

The current points for each gaming machine and intermediate and final standings for each of the machines may be displayed on gaming machines 101-106. In one or more embodiments, tournament status information is also displayed on a shared gaming display 120 as part of a sign 110. Sign 110 may be controlled by a gaming display control computer (not shown), described further below. Once all tournament prizes have been awarded, gaming machines 101-106 resume normal stand-alone operation until the next group play tournament is triggered.

A pool for group awards is accumulated during normal play as a percentage of regular game play, such as three percent of the overall wagers. The total rake is pooled and the prizes are sized according to the preferences of the casino operator. In one instance, there may be only three awards, first place is 50% of the pool, second place is 30% of the pool, and third place is 20% of the pool. In this instance, the prizes are progressive and dependent upon the amount of play prior to initiating the group game play. In another aspect, the prizes may be set amounts established by the casino operator from non-coin in dollars, such as marketing dollars.

As discussed above and later below, a collection of electronic gaming machines (EGM's) that are configured for slot tournament or group play may be networked to a controller or server that may monitor and/or administer tournament or group play activity and may also provide one or more mystery bonus feature games and/or awards. The EGM's may be used in a conventional (non-tournament mode), which may not affect the tournament bonus activity. When the EGM's are in tournament or group play mode (non-conventional), then each EGM may sends its play activity to the group play controller or server.

Similarly, EGM's that are in conventional mode may communicate with casino accounting systems, such as a Bally CMS (Casino Management System) and/or SMS (Slot Management System), over the network and provide EGM accounting and player tracking data. The casino accounting systems, in turn, may provide network supported services such as voucher, wager account transfer (WAT), bonus, or progressive related services. EGM's that are in tournament mode typically do not alter the conventional accounting meters, thus they may disconnect from the casino accounting system during tournaments. Either way, the EGM's may continue to communicate to casino systems any critical security information, such as main door open or cash-box removed.

A CMS or SMS system server or group game controller may be configured to use a wide variety of scoring criteria to determine tournament and/or group play winners. The EGM's may communicate the group play activity to the system server or group game controller including the EGM's tournament or group play data. The system server or group game controller may calculate a real-time ranking of players at each of the participating EGM's based upon the scoring criteria, and ultimately determine the final player rankings at the conclusion of the tournament or group play. Each EGM sends the system server any data relevant to the performance of the current tournament or group game play; the data includes, but is not limited to, the total wagers, total points won, time elapsed/remaining, games played/remaining, and particular winning symbol combinations. This data can also be used for the purposes of awarding a bonus payment to the tournament or group play player.

There are a variety of bonus and progressive award methods that may be used. The following is a list of bonus award methods:
Mystery bonus based on aggregate tournament wagers reaching a pre-selected random value.
Mystery bonus based on aggregate tournament winnings reaching a pre-selected random value.
Mystery bonus based on aggregate tournament game plays reaching a pre-selected random value.
Mystery bonus based on elapsed tournament play time reaching a pre-selected random time.
Progressive bonus based on individual tournament winnings reaching a configured trigger point.
Progressive bonus based on individual tournament game plays reaching a configured trigger point.
Progressive bonus based on highest tournament winnings within a tournament.
Progressive bonus based on particular symbol combination on tournament game play per single handle pull.

Tournament bonus and/or progressive awards may be manually dispensed by the tournament host (attendant pay) terminal, or automatically dispensed by the EGM. The awards may be dispensed in a variety of forms or combinations of forms, such as (but not limited to) currency, printed voucher or coupon, electronic funds transfer, smart card, and/or player club points. For most award dispensing methods, interaction between the EGM, tournament system server, and casino systems may be required. Non-cash awards may also be provided, for example: vacations, free buffet, show tickets, or a number of tournament points added to the tournament player's score.

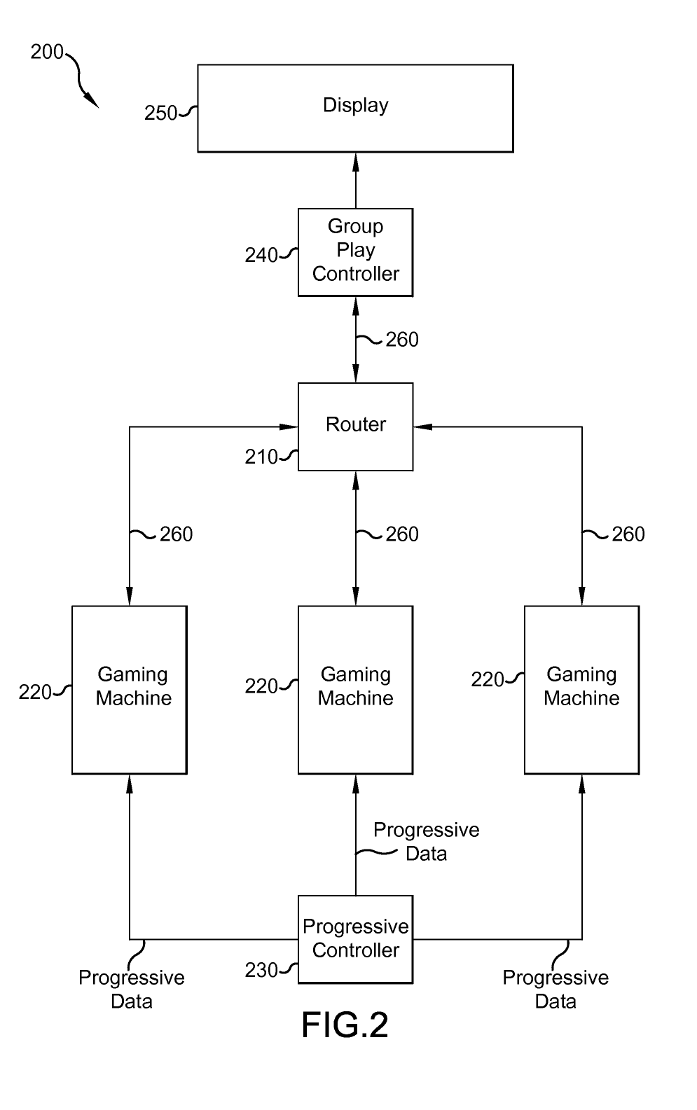

Referring to FIG. 2, in accordance with one aspect of the invention, networked group play gaming system 200 includes gaming machines 220, progressive controller 230 and group play controller 240, which may be connected to one or more displays 250. Router 210 and other networking components (not shown) may facilitate communications across network 260 between at least group play controller 240 and gaming machines 220.

In accordance with one or more embodiments, gaming machines 220, such as commercially available CineReel™ slot machines running the Alpha OS gaming software platform by Bally Technologies, Inc., may be modified as by modification of the Alpha OS gaming software or by addition of a group play gaming module executable together with the Alpha OS gaming software to enable group game play as described herein and shown together with the figures and flowcharts, so that gaming machines 220 may operate in a group play or tournament mode and communicate with group play controller 240 through network 260 during group or tournament play. In various embodiments of the network shown in FIG. 2, the gaming machines 220 may be mechanical reel spinning slot machines, video slot machines, video poker machines, keno machines, video blackjack machines, gaming machines of any other type provided it can be modified and operatively connected to the network for participation in group play, and combinations thereof. In one or more embodiments, gaming machines 220 may provide one or more games as a set of multiple primary games with an individual game selected for play by a random number generator.

Group play controller 240 facilitates the transfer of information concerning group play events to and from gaming machines connected to the network. In one or more embodiments, when a gaming machine 220 initiates the group play feature, it notifies group play controller 240. Group play controller 240 then forwards this information to all machines 220 on the network 250. Group play controller 240 waits for an acknowledgement from all machines 220, then directs all eligible machines 220 to start a group play feature. During group play, each machine 220 transmits its current group play status, for example, current tournament points, to group play controller 240. Group play controller 240 may then forward this to the other participating gaming machines 220 or use this information to display a leader-board or other group play information on display 250. For example, these displays may include progressive pool amounts, tournament standings and the like.

In accordance with one or more embodiments of the invention, group play displays may be presented on displays operated by a separate display control computer (not shown), such as a reconfigurable gaming display. An example of a reconfigurable display control computer, such as a SignStudio™ by Bally Technologies, Inc., is disclosed in U.S. application Ser. No. 11/463,793, entitled “Reconfigurable Gaming Display and System,” filed on Aug. 10, 2006, which is hereby incorporated by reference in its entirety.

In accordance with one or more aspects of the invention, during its boot sequence, a gaming machine 220 attempts to connect to the group play controller 240 using TCP/IP. Gaming machine 220 transmits a registration package containing a unique identifier for that machine. Group play controller 240 may respond with either an approval or denial packet. For example, a denial packet could be sent if group play controller 240 already has a maximum number of allowed gaming machines 220 registered.

In one embodiment, the first machine 220 to register with group play controller 240 is sent a packet enabling it as a “master progressive communicator.” During regular game play, the master progressive communicator periodically transmits a packet to the group play controller 240 containing the current progressive amounts, which gaming machine 220 has in turn received from progressive controller 230. Group play controller 240 computer may use these packets to update progressive pool “odometers” on one or more displays 250.

Progressive controller 230 may be a known industry-standard progressive controller such as a controller manufactured by Mikohn, Inc. Progressive controller 230 monitors wagering during regular play at each of the gaming machines 220, calculates a current value for one or more progressive jackpot pools and transmits the current pool values to the gaming machines 220. In the event of a winning jackpot at one of the gaming machines 220, the gaming machine notifies progressive controller 220 that a particular jackpot has occurred. Progressive controller 230 calculates a final progressive jackpot value and broadcasts the amount and the winning event to each of the gaming machines 220. Progressive controller 230 then resets the value of the won progressive pool to a predetermined starting point. In some embodiments, the connection between progressive controller 230 and gaming machines 220 is the same as the connection between the other network components. In other embodiments, the connection between the progressive controller 230 and the gaming machines 220 is a different hardware and software connection, for example, RS-232. In accordance with one or more aspects of the invention, one of the gaming machines 220 may be assigned the role of passing progressive pool information received from progressive controller 230 to group play controller 240. In one or more embodiments, group play controller 240 has a dedicated connection to progressive controller 230 for the purpose of monitoring progressive pool status in order to update display 250 with the values of the various progressive pools.

In one or more alternate embodiments of the invention, progressive controller 230 may be implemented as part of the software functionality of one or more of the gaming machines 220. In still other embodiments, progressive controller 230 may be implemented as part of the software functionality of group play controller 240.

One or more embodiments of the network include a TCP/IP connection 260 between router 210, group play controller 240 and gaming machines 220. Any compatible means for operatively linking the various devices may be used such as CAT5 ethernet cable or a wireless connection. Other embodiments provide different hardware and protocol implementations, for example, an RS-485 network may be used to form connection 260. In one or more embodiments, machines 220 periodically transmit a ‘ping’ packet to, and in return receive a ‘pong’ packet from, group play controller 240 to ensure that group play controller computer 240 ‘knows’ that all machines 220 are operational and that the gaming machines 220 ‘know’ that group play controller 240 is operational. In one or more embodiments, group play controller 240 and gaming machines 220 may detect if the TCP/IP communication line is broken using capabilities of the TCP/IP protocol.

In the example embodiment shown in FIG. 1, networked gaming machines 101-106 are located in close proximity to one another in a bank of six gaming machines, however, a gaming system of the type described above also allows a plurality of games in accordance with various embodiments of the invention to be linked for cooperative or competitive play in a particular area, carousel, casino or between casinos located in geographically separate areas by way of local area network (LAN) or wide-area network (WAN) topologies, alone or in combination.

One will appreciate that a gaming system in accordance with one or more aspects of the invention may also include other types of components, and the above illustrations are meant only as examples and not as limitations to the types of networking components, gaming machines or games. For example, group play controller 240 may be part of a central host computer system, such as a player tracking host or a “back-end” server. Additionally, it may further be appreciated that each of the games could be operated on a remote host computer such that a player initiates play with the host computer over a network via a player interface and each gaming machine 220 operates the respective gaming and video displays in conjunction with the game whose play is controlled by the remote computer.

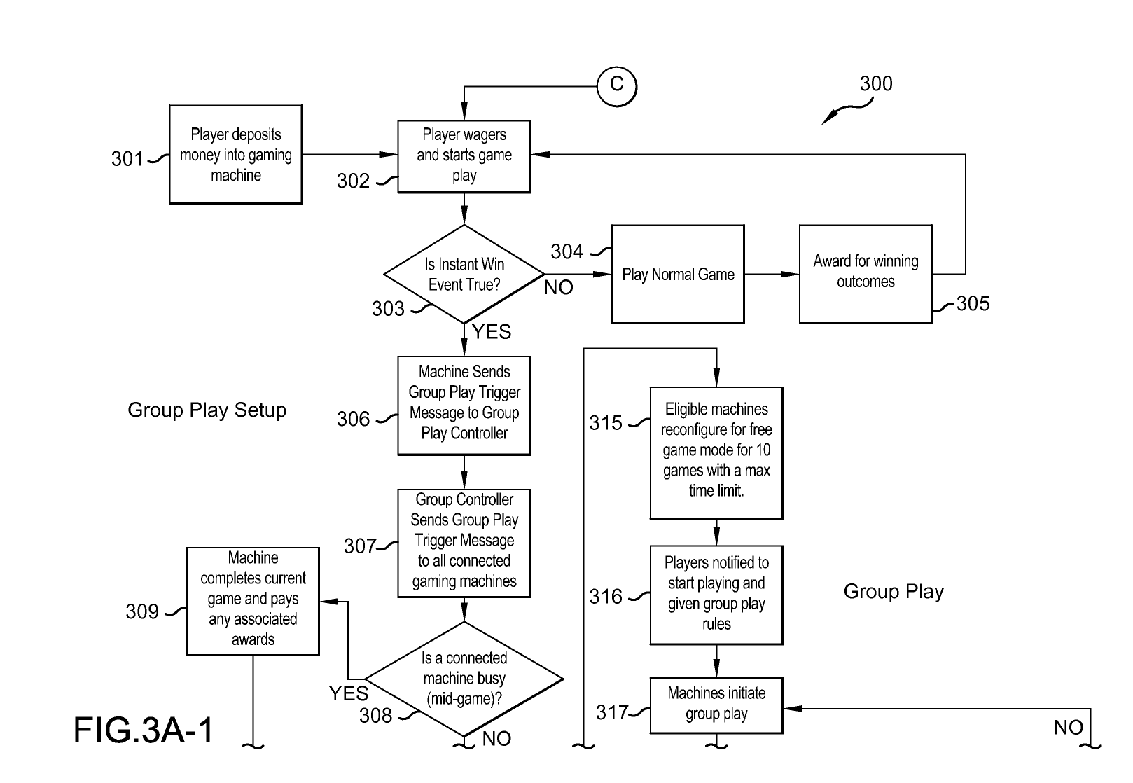

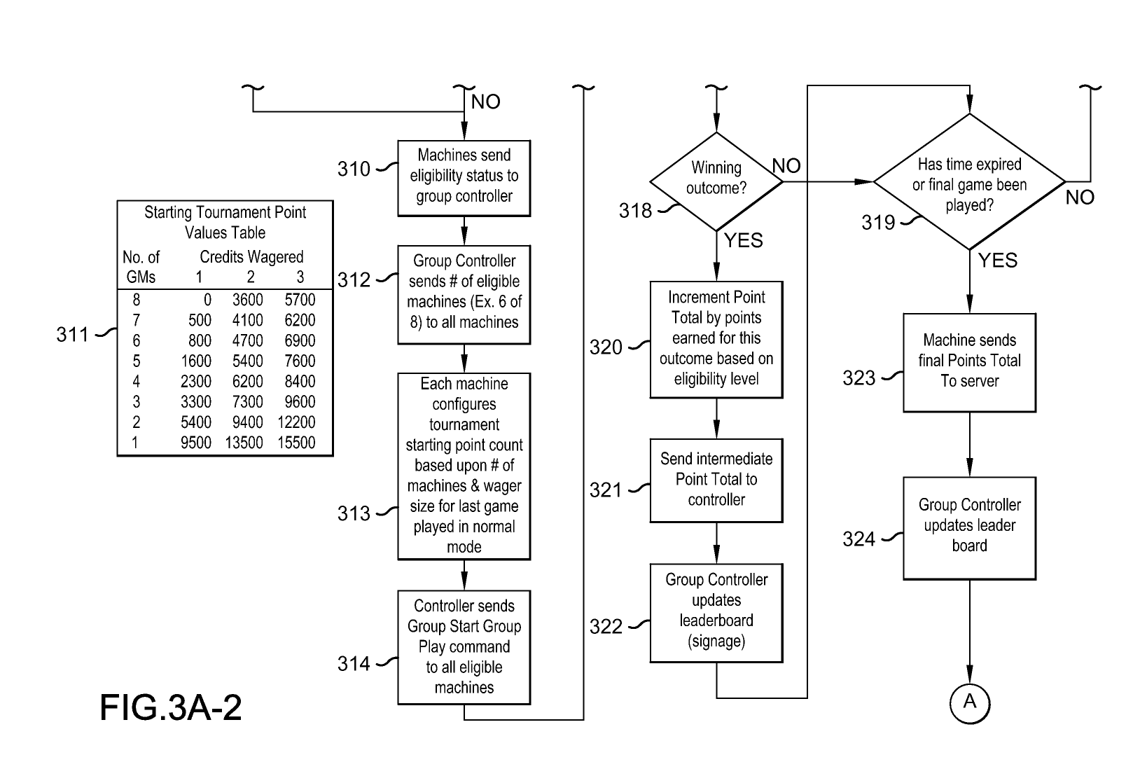

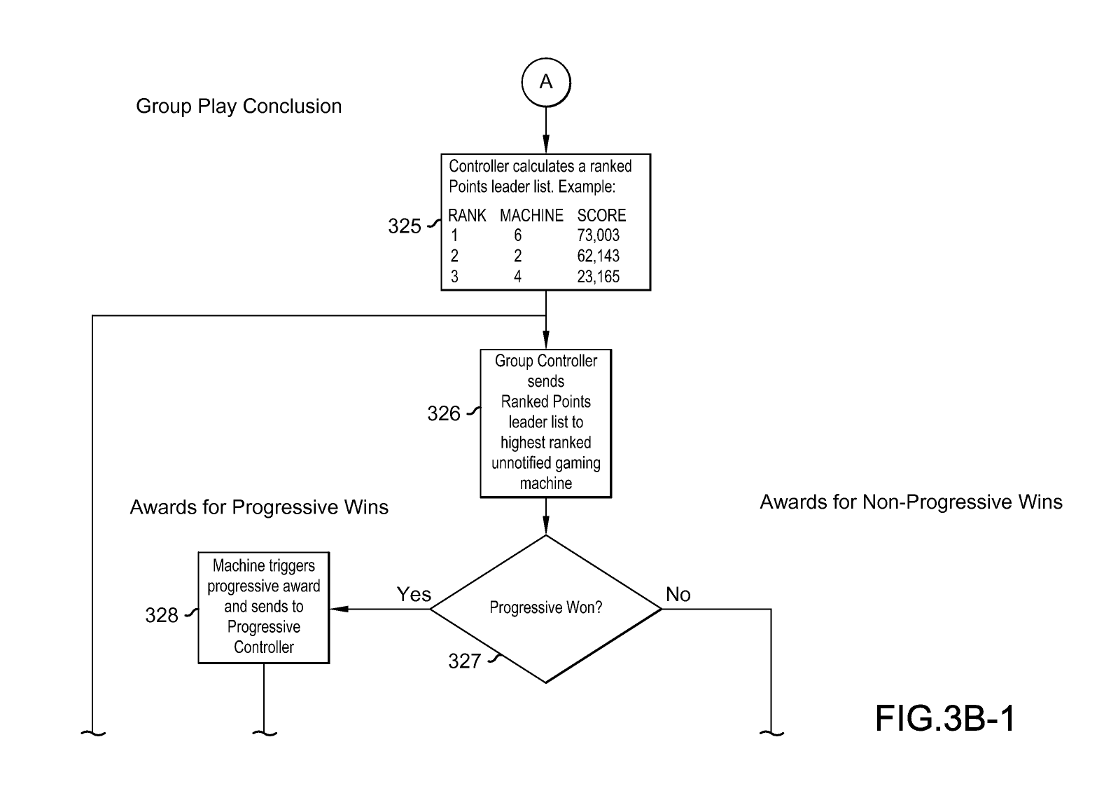

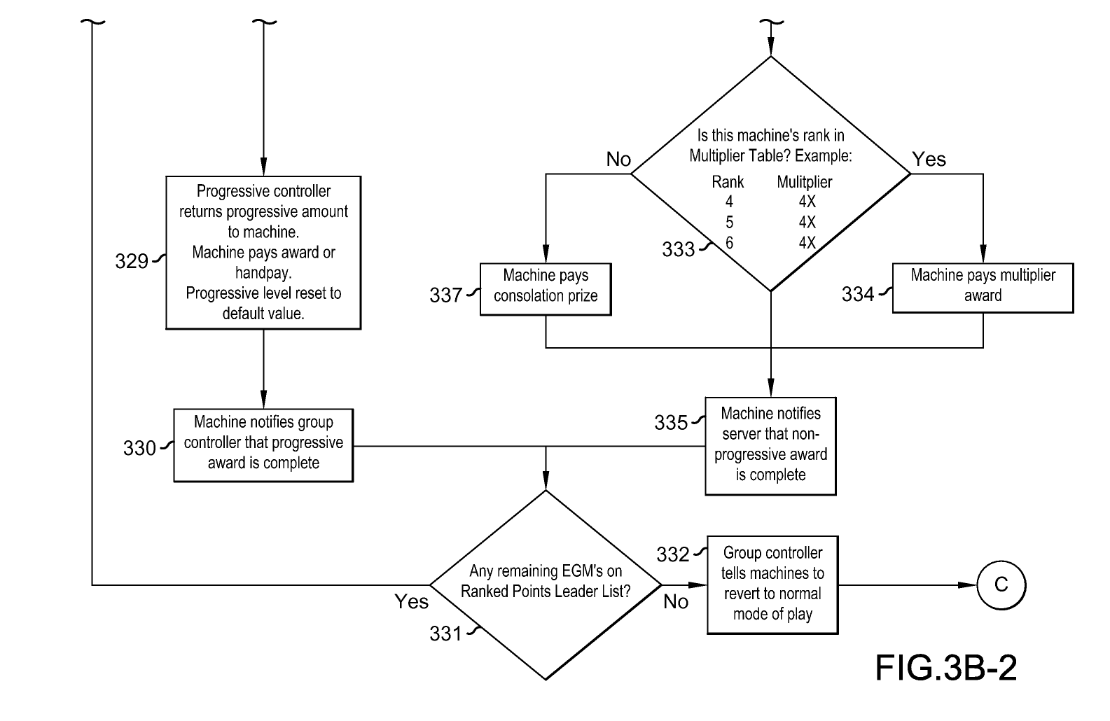

Referring to FIGS. 3A and 3B, a logical flow diagram generally depicting the steps associated with an example method 300 for carrying out a group play event in accordance with one or more aspects of the invention is shown. The order of actions as shown in FIGS. 3A-3B is only illustrative, and should not be considered limiting. For example, the order of the actions may be changed, additional steps may be added or some steps may be removed without deviating from the scope and spirit of the invention. For each of the gaming machines connected to the group play controller, one or more steps of method 300 are performed, as will be further described below.

At step 301, a player deposits money into a gaming machine by way of currency, voucher, coin, electronic transfer or the like. At step 302, the player initiates game play on a gaming machine by placing a wager and pressing a start or spin button.

The gaming machine makes an “instant win” determination at step 303 to determine if a group play game should be played. An “instant win” is a game triggered by an event not related to a game play outcome, one or more examples of which are disclosed in U.S. application Ser. No. 11/428,220, entitled “Multiple Primary Games Triggered by Random Number Generator,” filed on Jun. 30, 2006, hereby incorporated in by reference its entirety. Briefly, after receiving a wager, the gaming machine determines which of one or more primary game to activate. In one or more embodiments of the present invention, an instant win determination occurs when a “spin,” “repeat bet,” or “max bet” button is pressed by a player at one of the linked gaming machines. A random number is selected from a random number range, for example, 1-192. If the selected number does not match a predetermined value within the range, for example, the predetermined value is “1” and the selected value is one of the set of values from 2-192, inclusive, normal game play occurs at step 304. Any award(s) for winning outcome(s) are paid to the player at step 305 and control returns to step 302 for another play of the gaming machine.

If, however, the random number drawn at step 303 matches the predetermined value within the range, again, for example, “1”, the group play game is triggered in lieu of normal play on the gaming machine. It should be noted that the triggering gaming machine may be, at a given moment, any of the gaming machines connected to the group play network.

If the instant win determination is true at step 303, the triggering gaming machine sends a group play trigger message to a group play controller at step 306. In response, the group play controller forwards the group play trigger message to all other gaming machines connected to the group play controller at step 307.

If a receiving gaming machine is busy, in the middle of a game, for example, when the group play trigger message is received at step 308, the machine completes the current game and pays any associated wins at step 309. Once the gaming machine is not busy, it determines whether it is eligible to participate in group play according to pre-established rules. By way of example, and not by limitation, any connected machine that did not trigger the feature may participate in group play if it met the pre-determined entry criteria, such as having performed a normal game play within ten seconds of the time the group play trigger message was received. It will be appreciated that the triggering gaming machine is automatically eligible for the group play. Each gaming machine responds to the group play trigger message with its eligibility status (eligible or not eligible) to the group play controller at step 310.

The Group play controller sends the number of eligible gaming machines (e.g., 6 of 8 machines) to all connected gaming machines at step 312. At step 313, each of the eligible gaming machines configure their respective tournament starting point count based upon the number of gaming machines in the tournament and wager size for the last game played in normal mode and sends the tournament controller or server the information. For example, box 311 provides an example lookup table used for assigning starting tournament points based on the number of eligible gaming machines and the number of credits wagered in the last normal game played. Rewarding players with higher wagers with a “head start” in group play may encourage players to wager more money during regular game play. In accordance with some embodiments, each gaming machine has a different table based on its game math model. In one embodiment, all starting point tables are the same.

In some embodiments, the number of gaming machines participating in the tournament and an individual gaming machine's wager size, such as last or average wager for the current player's gaming session prior to the tournament mode, may determine its “eligibility level.” A gaming machine's eligibility level may determine both the number of starting tournament points and which of a set of tournament point pay tables will be used during group play. For example, a winning outcome of a single CHERRY symbol might award one tournament point for a machine operating at eligibility level 1, whereas an identical machine operating at eligibility level 3 might be awarded three tournament points for the same winning game outcome. Allowing players with higher wagers during regular game play to accrue points in group play at a faster rate than those with lower normal game wagers may also encourage players to wager more money during regular game play.

Once all eligible gaming machines are ready, group play can begin. The group play controller sends a start group play command to all eligible gaming machines at step 314. The eligible gaming machines reconfigure themselves for group play, for example, enabling ten free games with a maximum time-out limit at step 315. The players at all eligible gaming machines are notified of the group play rules, and told to begin group play, step 316. Players may or may not interact with their gaming machine controls during group play, depending on the game being played. For example, a poker game might require player interaction while a slot machine game might not. In accordance with one or more embodiments, each gaming machine pay allowed a different number of free games according to the amount of the last wager during regular play. For example, a max bet player may be awarded additional bonus games over non-max bet players. Allowing players with higher wagers during regular game play more chances to accrue points in group play those with lower normal game wagers may generate more excitement for players and encourage players to wager more money during regular game play.

All eligible gaming machines initiate a free game at step 317. Each gaming machine checks the game outcome to see if it was a winning outcome according to the gaming machine's group play pay table at step 318. If not, the gaming machine checks to see if time has expired or if the game, for example, the tenth game, has been performed at step 319. If not, control returns to step 317 for another game. If a winning outcome was determined in step 318, the tournament point total for the winning gaming machine is incremented by the points earned for the outcome at step 320.

Each gaming machine sends it current point total to the group play controller at step 321. The group play controller uses the point total for display purposes, updating a leader board at step 322. The leader board may be replicated on a plurality of displays. The leader board is updated and may graphically display the threshold reached by each gaming machine with a corresponding arrow in a bar graph visually depicting the “upward” progress of all gaming machines. The leader board may be displayed on one or more displays controlled by a gaming display control computer or by the group play controller. An example of a leader board in accordance with one or more embodiments of the invention may be similar to the table shown in box 325.

Group play continues recursively for all eligible gaming machines between steps 317-322 as described above until each gaming machine determines it has completed its final spin in group play at step 319. As each gaming machine completes its final game in group play, it sends its final tournament point total to the group play controller at step 323. The group play controller updates the leader board at steps 324-325.

The group play controller generates a points ranked leader list based on the final point total of each participating gaming machine at step 325. The group play controller notifies each of the ranked gaming machines of the tournament outcome, step 326. The group controller recursively performs steps 326 and 331 until all gaming machines on the list have received and processed it at steps 327-335.

Each of the gaming machines compares its final ranking and final point total to an internal bonus round pay table to determine if it is in the top three finishing positions and, if so, whether the total points meet or exceed a threshold required for winning a progressive award at step 327. In one embodiment, which progressive has been won depends on the total number of points achieved. In another embodiment, one of a set of progressives is randomly chosen as the won progressive.

If a progressive award has been won, the gaming machine notifies the progressive controller at step 328, otherwise, control passes to step 333, described below. Upon notification of a progressive win, the progressive controller returns the amount of the designated progressive award to the winning gaming machine and the progressive pool is reset to a new starting value at step 329. The progressive award may be paid by way of hand pay, voucher or credits placed on the credit meter of the gaming machine. In one or more embodiments, the value associated with the progressive award may be placed directly into a system account associated with the winning player. The gaming machine next sends a message to the group play controller that a progressive award has been completed at step 330. The controller determines whether any gaming machines on the points ranked leader list need notification, step 331. If any un-notified gaming machines remain, control returns to step 326 for notification of the next gaming machine on the list. Otherwise, group play is complete. The group play controller sends a message to all gaming machines to return to regular game play at step 332 and control returns to step 302, FIG. 3A.

If, at step 327, above, a progressive prize has not been won, such as due to an insufficient number of points, the gaming machine then determines whether it is in the top three finishing positions at step 333. If so, a bonus multiplier, for example, 3×, is applied to the wager made in the last played regular game, and the resulting prize is awarded at step 334. If the gaming machine is not one of the top three ranked gaming machines, a consolation prize, which may also be a multiplier, for example, 2× is applied to the wager made in the game last played in the last played regular game, and is awarded at step 337. In one or more embodiments, the consolation prize is a fixed amount. Following the payment of a non-progressive award, the gaming machine sends a message to the group play controller that the award is complete at step 335. As described above, the controller determines whether any gaming machines on the points ranked leader list have not yet received notification, step 331. If any un-notified gaming machines remain, control returns to step 326 for the next gaming machine in the list. Otherwise, group play is complete. The group play controller sends a message to all gaming machines to return to regular game play at step 332 and control returns to step 302, FIG. 3A.

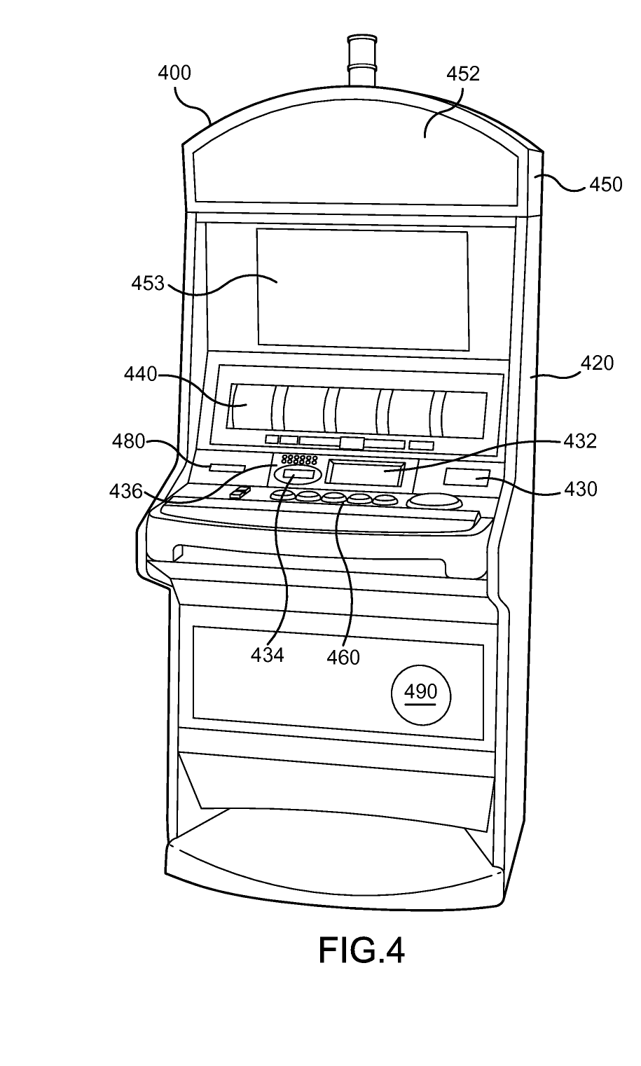

In accordance with one or more embodiments, FIG. 4 illustrates an example gaming machine 400 that may be modified for incorporation in the network of FIG. 2. Gaming machine 400 may be, by way of example and not by limitation, a modified CineReel™ slot machine running the Alpha OS gaming software platform by Bally Technologies, Inc. Gaming machine 300 includes cabinet housing 420, primary game display 440, player-activated buttons 460, player tracking panel 436, bill/voucher acceptor 480 and one or more speakers 490. Cabinet housing 420 is a self-standing unit that is generally rectangular in shape and may be manufactured with reinforced steel or other rigid materials which are resistant to tampering and vandalism. Cabinet housing 420 houses a processor, circuitry, and software (not shown) for receiving signals from the player-activated buttons 460, operating the games, and transmitting signals to the respective displays and speakers. Any shaped cabinet may be implemented with any embodiment of gaming machine 400 so long as it provides access to a player for playing a game. For example, cabinet 420 may comprise a slant-top, bar-top, cinema or table-top style cabinet. The operation of gaming machine 400 is described more fully below.

The plurality of player-activated buttons 460 may be used for various functions such as, but not limited to, selecting a wager denomination, selecting a game to be played, selecting a wager amount per game, initiating a game, or cashing out money from gaming machine 400. Buttons 460 function as input mechanisms and may include mechanical buttons, electromechanical buttons or touch screen buttons. Optionally, a handle (not shown) may be rotated by a player to initiate a game.

In other embodiments, buttons 460 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 420 may optionally include top box 450 which contains “top glass” 452 comprising advertising or payout information related to the game or games available on gaming machine 400. Player tracking panel 436 includes player tracking card reader 434 and player tracking display 432. Voucher printer 430 may be integrated into player tracking panel 436 or installed elsewhere in cabinet housing 420 or top box 450.

Game display 440 presents a game of chance wherein a player receives one or more outcomes from a set of potential outcomes. For example, in various aspects of the invention, gaming machine 400 may present a video or mechanical reel slot machine, a video keno game, a lottery game, a bingo game, a Class II bingo game, a roulette game, a craps game, a blackjack game, a mechanical or video representation of a wheel game or the like.

In the example of FIG. 4, game display 440 includes a set of five electromechanical reels, however, other mechanical or video/mechanical embodiments may include game displays such as one or more video displays, wheels, or dice as required to present the game to the player. In video/mechanical or pure video embodiments, game display 440 is, typically, a CRT or a flat-panel display in the form of, but not limited to, liquid crystal, plasma, electroluminescent, vacuum fluorescent, field emission, or any other type of panel display known or developed in the art. Game display 440 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide.

Additionally, game display 440 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference.

In one or more embodiments of the invention, game display 440 may also present information such as, but not limited to, player information, advertisements and casino promotions, graphic displays, news and sports updates, or even offer an alternate game. This information may be generated through a host computer networked with gaming machine 400 on its own initiative or it may be obtained by request of the player using either one or more of the plurality of player-activated buttons 460; the game display itself, if game display 440 comprises a touch screen or similar technology; buttons (not shown) mounted about game display 440 which may permit selections such as those found on an ATM machine, where legends on the screen are associated with respective selecting buttons; or any player input device that offers the required functionality.

Cabinet housing 420 incorporates a single game display 440. However, in alternate embodiments, cabinet housing 420 or top box 450 may house one or more additional displays 453 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

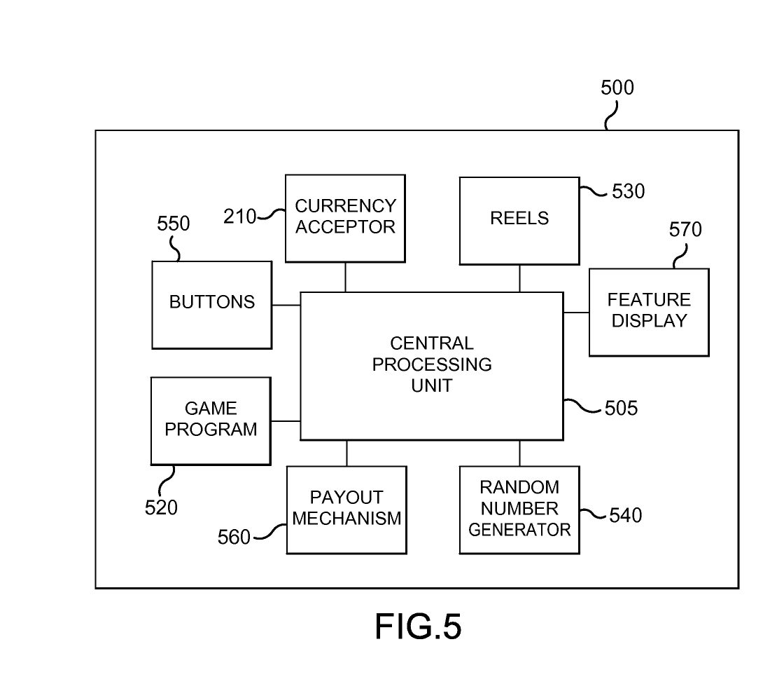

In accordance with one embodiment of the present invention, FIG. 5 is a block diagram showing an example interconnection 500 of physical and logical components of gaming machine 400. Currency acceptor 510 is typically connected to a conventional central processing unit (“CPU”) 505, such as an Intel Pentium microprocessor mounted on a gaming motherboard, by a serial connection such as RS-232 or USB. The gaming motherboard may be mounted with other conventional components, such as are found on conventional personal computer motherboards, and loaded with a gaming machine operating system (OS), such as an Alpha OS installed within a Bally S9000, M9000 or CineVision™ slot machine. CPU 505 executes game program 520 that causes reels 530 to display a game. In one embodiment, game program 520 is a game entitled Super Tournament Progressives.

When a player has inserted a form of currency such as, for example and without limitation, paper currency, coins or tokens, cashless tickets or vouchers, electronic funds transfers or the like into currency acceptor 510, a signal is sent to CPU 505 which, in turn, assigns an appropriate number of credits for play. The player may further control the operation of the gaming machine, for example, to select the amount to wager via electromechanical or touch screen buttons 550. The game starts in response to the player pushing one of buttons 550 or an alternate start mechanism such as a handle or touch screen icon (not shown). Random number generator 540 responds to instructions from CPU 505 to provide a display of randomly selected indicia on reels 530. In some embodiments, random generator 540 may be physically separate from gaming machine 400; for example, it may be part of a central determination host system (not shown) which provides random game outcomes to CPU 505. Thereafter, the player may or may not interact with the game through electromechanical or touch screen buttons 550 to change the displayed indicia. Finally, CPU 505 under control of game program 520 compares the final display of indicia to a pay table. The set of possible game outcomes may include a subset of outcomes related to the triggering of a feature game. In the event the displayed outcome is a member of this subset, CPU 505, under control of game program 520, may cause feature game play to be presented on feature display 570.

In one embodiment, reels 530 are electromechanical reels. Game program 520 includes reel spinning firmware to provide proper signals for driving multiple stepper motors (not shown), which, in turn, spin the reels 530. Preferably, the motors are driven using a “full step” excitation sequence in which a single motor step is preformed by changing the excitation on one of the two-phase inputs in a specified sequence. The sequence determines whether the direction implemented is forward or reverse. The reel drive pulse trains go through three distinct stages: acceleration, steady state, and deceleration. During acceleration, reels 530 are driven with a pulse frequency that is less than the maximum “start/stop” frequency. Typically, if a motor is attempted to be started with a high frequency pulse, the motor loses synchronization and slips. Therefore, preferably the drive frequency is incrementally increased until the steady state drive frequency is reached. At steady state, reels 530 are driven for a specified number of steps at the maximum drive frequency before going to the deceleration phase. During deceleration, the process is reversed and the drive frequency decreased until the stopping frequency is reached. Preferably, this procedure helps to prevent reels 530 from slipping past the proper stop position on deceleration. Finally, at the stopping point, the motor excitation signals are held constant.

In one embodiment, the primary game reels are not used for the feature play; instead, a wheel or other feature display 570 is used to present the feature game outcomes. The feature display may be an electromechanical device, may present the feature on a video display or both.

Predetermined payout amounts for certain outcomes, including feature game outcomes, are stored as part of one or more game programs 520. Such payout amounts are, in response to instructions from CPU 505, provided to the player in the form of coins, credits or currency via payout mechanism 560, which may be one or more of a credit meter, a coin hopper, a voucher printer, an electronic funds transfer protocol or any other payout means known or developed in the art.

In various embodiments of gaming machine 400, game program(s) 520 is/are stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 400 are stored in the same or a separate memory device (not shown). Some or all of game programs 520 and associated data may be loaded from one memory device into another, for example, from flash memory to random access memory (RAM).

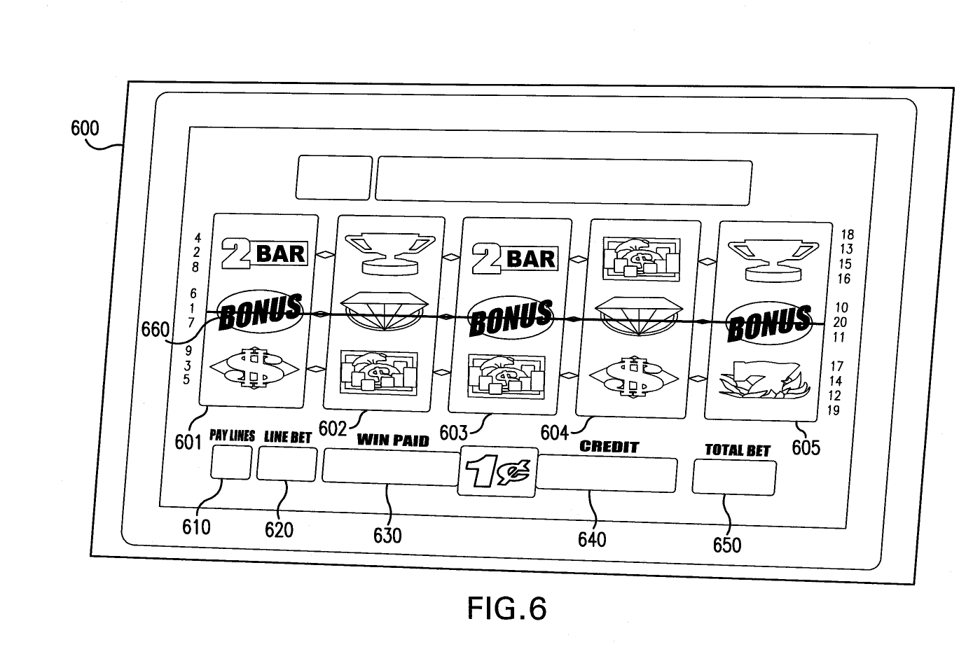

An example game in accordance with one or more aspects of the invention is shown in FIGS. 6-9. Referring to FIG. 6, game 600 is implemented using five spinning reels 601-605. Each of 30 pay line patterns (not shown) passes through one indicium on each of the five reels. For example, the first pay line 660 extends horizontally through the center position of each of the five reels 601-605. The number of pay lines and their patterns are by way of example only and may vary. The player selects the number of played pay lines and the number of credits or coins wagered on each line using touch screen controls or gaming device control buttons. The player's selections are displayed on PAY LINES meter 610, LINE BET meter 620 and TOTAL BET meter 630 located adjacent to the reels. WIN PAID meter 640 and CREDIT meter 650 provide the player with information about the amount paid by the last game played and the total number of credits available for play. The player may collect the balance of his credits by pressing a COLLECT button (not shown).

The player initiates game play by pressing a SPIN button (not shown). In some embodiments, the player may simultaneously select all pay lines at the maximum number of coins or credits allowed per line by pressing a MAX BET button. Buttons (see FIG. 4, 460) on gaming machine 400 (FIG. 4) or touch screen buttons (not shown) may be used to perform the actions described here without deviating from the scope of the invention. Reels 601-605 are made to spin and stop in predetermined stop positions. A determination is then made whether the stop positions of the reels resulted in a winning game outcome.

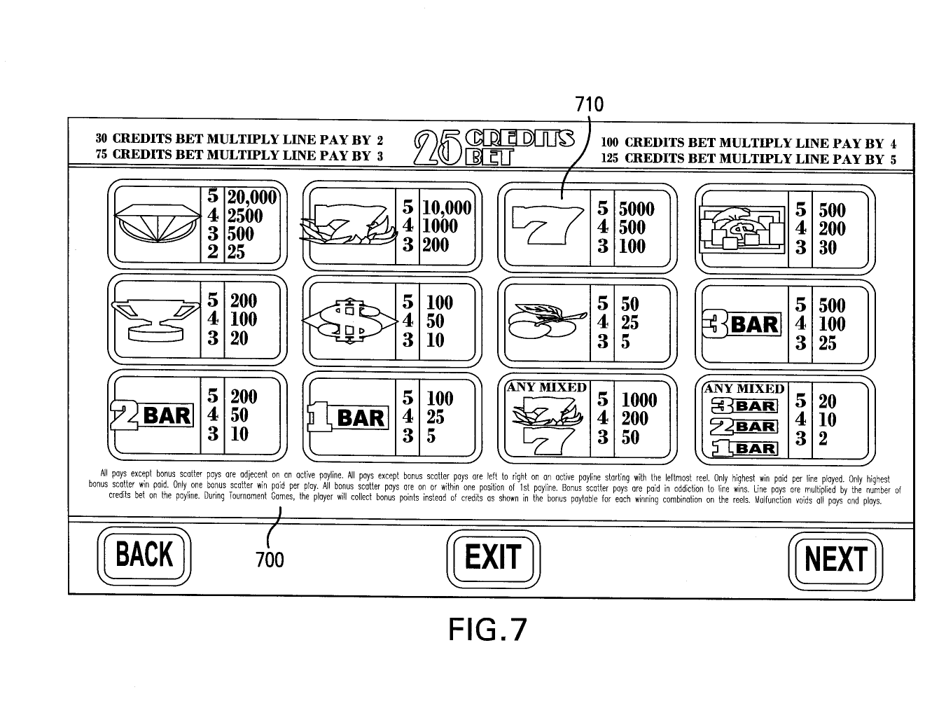

In accordance with one embodiment, part of an example pay table 700 is shown in FIG. 7. The pay table may be accessible through a HELP/PAYS or similar button. In alternate embodiments, the pay table may be presented on a second video or printed display attached to the gaming device (i.e. display 453 or “pay glass” 452, FIG. 4). A winning combination, for example, could be three or more symbols adjacent to one another on an active pay line. For each winning combination, the game device awards the player the award in the pay table, adjusted as necessary based on the number of credits wagered on the pay line on which the win occurred. For example, three RED 7 symbols 710 adjacent to one another from left-to-right on an active pay line would pay 100 times the player's wager. In some embodiments, video representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to be result in pay amounts in excess of the normal winning combination by way of multiplication or addition, for example, a wild doubler symbol may be used.

As described above, an “instant win” may trigger play of a group play game. In one embodiment, a wager of a certain amount may be required in order to be eligible for participation in group play. For example, the player may be required to play the maximum wager in order to be eligible.

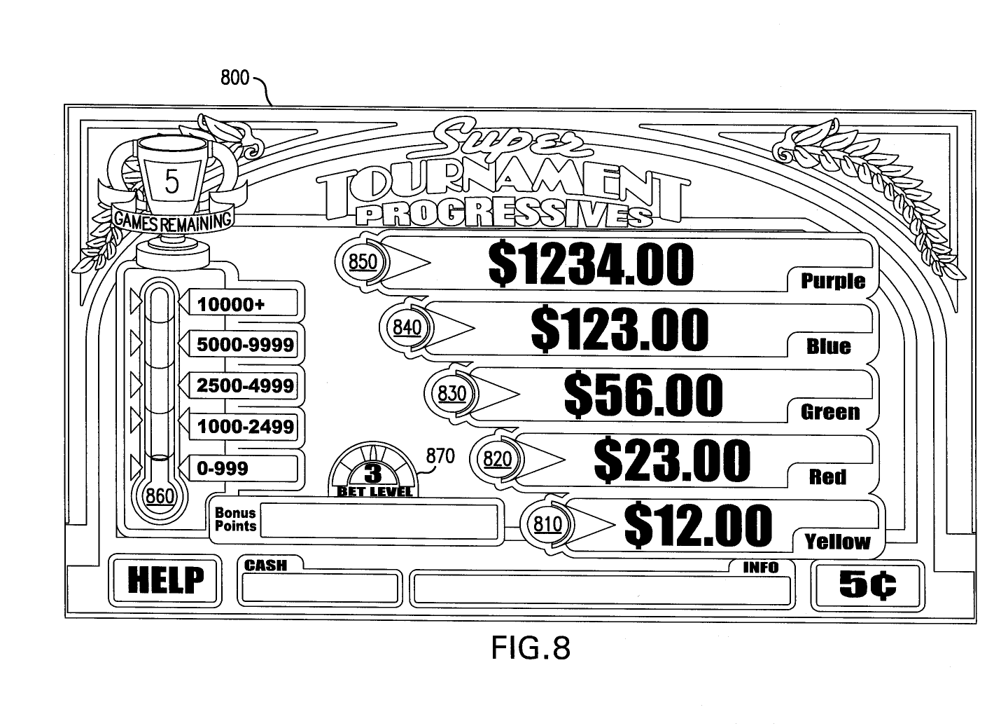

Referring to FIG. 8, in accordance with one or more embodiments of the invention, display 800 presents an example screen from a group play game in which a tournament mode allows the player to play the base game for free for a certain period of time, accumulating points, rather than credits, for winning base game outcomes. At the conclusion of tournament play, the player may be awarded one of five progressive values 810, 820, 830, 840, 850 based on the number of tournament points 860 acquired during play of the group play game as shown by the bonus points display area and thermometer. The player may also be awarded a non-progressive prize based on his bet level 870 prior to starting group play.

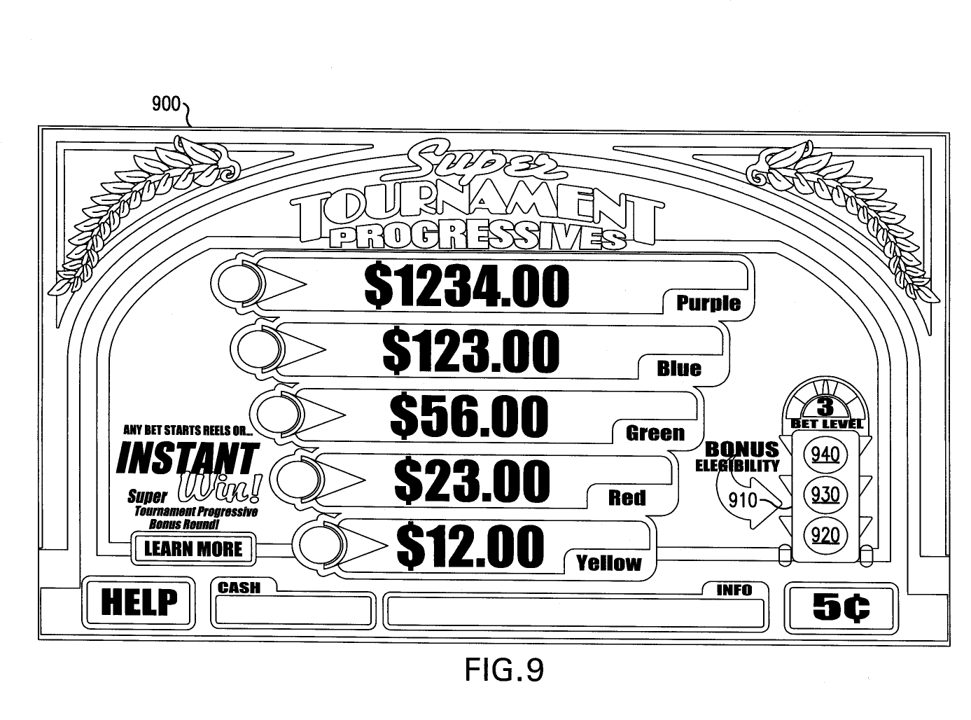

Referring to FIG. 9, in accordance with one or more embodiments of the invention, the game may include an indicator by which a player may know whether his machine is currently eligible for group play should a trigger occur. For example, but not limited to, a “stoplight”-type graphic 910 may indicate group play eligibility to the player, with an illuminated “Green” position 920 indicating the gaming machine is eligible, a “Yellow” position 930 indicating that the gaming machine only has a few seconds of eligibility remaining, and “Red” position 940 indicating that the gaming machine is no longer eligible.

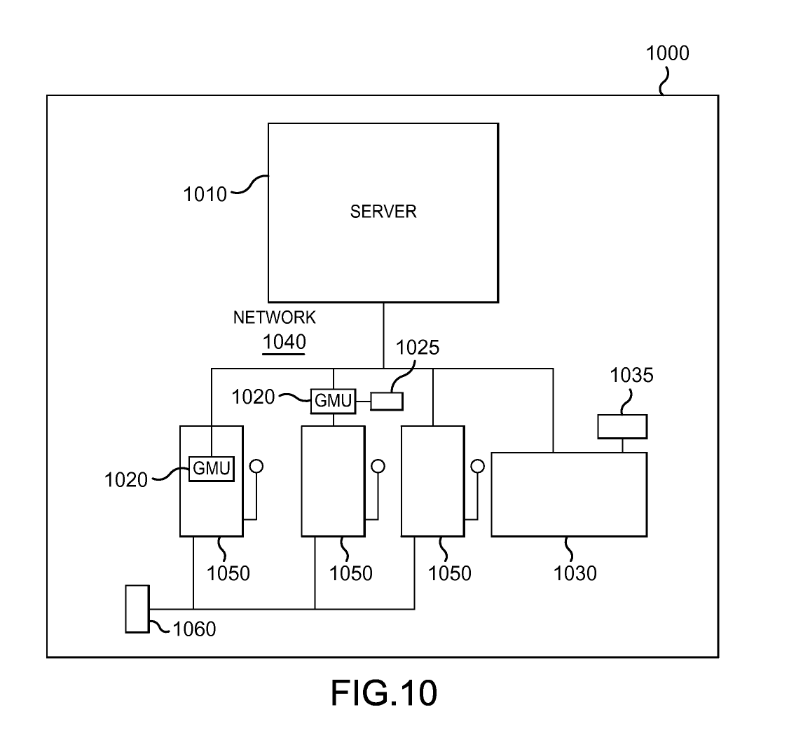

Referring to FIG. 10, in accordance with one or more aspects of the invention, the example group play gaming system of FIG. 2 may itself be part of a larger example gaming system 1000, which includes server 1010, gaming machines 1050, and network 1040 connecting gaming machines 1050 to server 1010. Additionally, gaming machine 1050 are shown connected to group gaming controller 1030 and progressive controller 1060 as described in FIG. 2. Server 1010 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 1010 may be configured as a single “logical” server that comprises multiple physical servers. Gaming machines 1050 operate similar to conventional peripheral networked terminals. Gaming machines 1050 have a player interface such as a display, a card reader, and selection buttons through which gaming machines 1050 interact with a player playing a group game in accordance with various embodiments of the invention. The player interface is used for making choices such as the amount of a bet or the number of lines to bet. Gaming machines 1050 also provide information to server 1010 concerning activity on gaming machines 1050 and provide a communication portal for players with server 1010. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 1050 may be a mechanical reel spinning slot machine, video slot machine, video poker machine, keno machine, video blackjack machine, or a gaming machine offering one or more of the above described primary games including a group play game. Alternately, gaming machines 1050 may provide a group game as one of a set of multiple primary games selected for play by a random number generator, as described above. Networking components (not shown) facilitate communications across network 1040 between the system server 1010 and game management units 1020 and/or gaming display control computers 1030 that control displays for carousels of gaming machines. Game management units (GMU's) 1020 connect gaming machines to networking components and may be installed in the gaming machine cabinet or external to the gaming machine. The function of the GMU is similar to the function of a network interface card connected to a desktop personal computer (PC) and it may contain tracking software which provides notification to the casino of certain events on a gaming machine 750, including wins. Depending upon the casino management system, payouts on large wins at gaming machines 1050 may be made directly to a player account managed by the host computer; in which case, the player is notified by way of the GMU at gaming machine 1050 that the player's account has been credited.

Some GMU's have much greater capability and can perform such tasks as presenting and playing a game having a group gaming aspect using a display 1025 operatively connected to GMU 1020. In one embodiment, GMU 1020 is a separate component located outside the gaming machine. Alternatively, in another embodiment, the GMU 1020 is located within the gaming machine. Optionally, in an alternative embodiment, one or more gaming machines 1050 connect directly to the network and are not connected to a GMU 1020. Displays related to group games played on gaming machines 1050 or GMU displays 1025 may also be presented on gaming display 1035 by group gaming controller 1030. Group gaming controller is also shown connected to network 1040, through which is may be capable of receiving reconfigured displays for presentation on display 1035. A gaming system of the type described above also allows a plurality of games in accordance with the various embodiments of the invention to be linked under the control of server 1010 for cooperative or competitive play in a particular area, carousel, casino or between casinos located in geographically separate areas.

The various embodiments described above are provided by way of illustration only and should not be construed to limit the claimed invention. For example, it may further be appreciated that each of the games could be operated on a remote host computer such that a player initiates play with the host computer over a network via the player interface and each gaming machine operates the respective gaming and video displays in conjunction with the game whose play is controlled by the remote computer. The top three players in group play mode may not be awarded progressives, but instead compete in a “Tournament of Champions,” or second group play event, with the victor receiving the top-level progressive. In one or more embodiments, all eligible players may be given the option to take a fixed credit amount or a wager multiplier award in lieu of competing in group play. In accordance with another aspect, ineligible players are given an option to “buy” their way into the group play. Similarly, eligible players may be given an option to buy a better starting point value for group play by paying a certain credit amount.

Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A networked group play gaming system comprising:
a group play controller;
a plurality of gaming machines operably connected to the group play controller and operable in a group play mode to compete for one or more awards based on achieving a highest score;
the group play controller providing one or more additional mystery awards based on scoring criteria other than the highest score.

2. The system as in claim 1, wherein at least one of the gaming machines transmits data relevant to the performance of the group game play to the group play controller.

3. The system as in claim 2, wherein the data comprises at least one of:
total wagers,
total tournament points won by the at least one gaming machine,
time elapsed,
time remaining,
games played,
games remaining, and
gaming machine symbol combinations.

4. The system as in claim 1, the scoring criteria being based on at least one of:
aggregate tournament wagers of one or more gaming machines reaching a pre-selected random value,
aggregate tournament winnings of one or more gaming machines reaching a pre-selected random value,
aggregate tournament game plays of one or more gaming machines reaching a pre-selected random value,
elapsed tournament play time reaching a pre-selected random time, and
a particular symbol combination obtained on a gaming machine.

5. The system as in claim 1, the one or more awards automatically dispensed by one or more of the plurality of gaming machines.

6. The system as in claim 5, the one or more awards comprising one or more of:
a printed voucher,
a coupon,
an electronic funds transfer,
a smart card credit, and
player club points.

7. The system of claim 1, at least one of the one or more awards comprising an attendant pay.

8. The system of claim 1, the one or more awards comprising a non-cash award.

9. The system of claim 8, the non-cash award comprising at least one of:
a vacation,
a free buffet,
one or more show tickets, and
a number of tournament points added to a player's tournament score.

10. A networked group play gaming system comprising:
a group play controller;
a plurality of gaming machines operably connected to the group play controller and operable in a group play mode to compete for one or more awards based on achieving a highest score;
the group play controller providing one or more additional progressive awards based on scoring criteria other than the highest score.

11. The system as in claim 10, wherein at least one of the gaming machines transmits data relevant to the performance of the group game play to the group play controller.

12. The system as in claim 11, wherein the data comprises at least one of:
total wagers,
total tournament points won by the at least one gaming machine,
time elapsed,
time remaining,
games played,
games remaining, and
gaming machine symbol combinations.

13. The system as in claim 10, the scoring criteria being based on at least one of:
aggregate tournament wagers of one or more gaming machines reaching a pre-selected random value,
aggregate tournament winnings of one or more gaming machines reaching a pre-selected random value,
aggregate tournament game plays of one or more gaming machines reaching a pre-selected random value,
elapsed tournament play time reaching a pre-selected random time, and
a particular symbol combination obtained on a gaming machine.

14. The system as in claim 10, the one or more awards automatically dispensed by one or more of the plurality of gaming machines.

15. The system as in claim 14, the one or more automatically dispensed awards comprising one or more of:
a printed voucher,
a coupon,
an electronic funds transfer,
a smart card credit, and
player club points.

16. The system as in claim 10, at least one of the one or more awards comprising an attendant pay.

17. The system as in claim 10, the one or more awards comprising a non-cash award.

18. The system as in claim 17, the non-cash award comprising at least one of:
a vacation,
a free buffet,
one or more show tickets, and
a number of tournament points added to a player's tournament score.

19. A group play game comprising:
a base game initiatable by a player and including a group play game initiator outcome;
after an occurrence of the group play game initiator outcome, a group play signal being initiated to query eligibility of one or more additional players;
after identification of two or more group play players, a group play session being initiated wherein the players may compete for two or more prizes or awards based on two or more respective criteria.

20. A method of operating a group play game including the steps of:
providing a base game initiatable by a player and including a group play game initiator outcome;
after an occurrence of the group play game initiator outcome, initiating a group play signal and querying eligibility of one or more additional players;
identifying two or more group play players based on one or more criteria;
initiating a group play session wherein the group play players compete for two or more prizes or awards based on two or more respective criteria.
